(19) United States
(12) Patent Application Publication
(10) Pub. No.: US 2010/0329711 A1
(43) Pub. Date: Dec. 30, 2010

(54) IMAGE FORMING APPARATUS PROVIDED WITH TONER DENSITY DETECTION SECTION

(75) Inventors: Tetsuya ISHIKAWA, Tokyo (JP); Toru KOMATSU, Tokyo (JP); Yasunori SHIGENAGA, Tokyo (JP)

Correspondence Address: CANTOR COLBURN LLP, 20 Church Street, 22nd Floor, Hartford, CT, 06103, US

(73) Assignee: KONICA MINOLTA BUSINESS TECHNOLOGIES, INC., Tokyo (JP)

(21) Appl. No.: 12/822,707

(22) Filed: Jun. 24, 2010

(30) Foreign Application Priority Data
Jun. 24, 2009 (JP) 2009-149691

(51) Int. Cl. G03G 15/00

(52) U.S. Cl. 399/49; 399/72

(57) ABSTRACT

An image forming apparatus includes a density sensor that measures density of patch images formed on an image carrier; and a controller that forms patch images having respectively plural density types in which image forming conditions are different respectively and corrects the image forming conditions based on measured density values of the patch images by the density sensor. The controller causes a first irradiation light amount by the light emitting section when measuring patch images whose ratio covered by toner of the image carrier is a prescribed value or more to be set different from a second irradiation light amount by the light emitting section when measuring patch images whose ratio covered by toner of the image carrier is less than the prescribed value.

This application is based on Japanese Patent Application No. 2009-149691 filed on Jun. 24, 2009, which is incorporated hereinto by reference.

### BACKGROUND OF THE INVENTION

The present invention relates to an image forming apparatus of an electrophotographic process, and in particular, to an image forming apparatus having a density detecting section that detects optically density of a toner image formed on an image carrier.

In an image forming apparatus of an electrophotographic process, there is used a technology to control image density to form an evaluation pattern called a patch image on an image carrier, then, to detect density of the patch image thus formed with a density sensor equipped with a light emitting section and a light receiving section and thereby to control image forming conditions for the image forming section based on results of the detection.

In the control of image density, there are demands for calculating a toner adhesion amount (image density) for a wide range of density covering from low density to high density in addition to intermediate density. In the case of a method to detect the toner adhesion amount with an optical density sensor for the demands mentioned above, there has been a problem that detecting sensitivity is lowered in the area of high toner adhesion amount, to make it impossible to correct normally.

In the image forming apparatus disclosed in Unexamined Japanese Patent Application Publication No. 06-186816, patch images are measured by an optical density sensor and by a surface potential sensor to obtain a relational expression between the surface potential and a toner adhesion amount for an area other than a high toner adhesion amount area, for the problem mentioned above, while, in the high toner adhesion amount area, a toner adhesion amount is calculated from the results of the measurements for surface potential of patch images and from the obtained relational expression.

A reflectance on the surface of an image carrier sometimes varies depending on dispersion between individuals, and even when the same patch image is measured, a detection value varies under the aforesaid influence, resulting in a fear that precise detection is impossible.

For the problem of this kind, there is a measure to conduct adjustment of an irradiation light amount so that a measured value may be within a prescribed range after measuring an image carrier on which a toner image is not formed, and it is possible to maintain the detecting precision by employing the aforesaid measure.

For the problem of dispersion between individuals for the reflectance on the image carrier, it is possible to maintain detecting precision for patch images covering a range from low density to intermediate density, by adjusting an irradiation light amount by the aforesaid measure. On the other hand, however, in the case of high density patch images such as solid images covering the total surfaces of the image carrier, if the irradiation light amount is changed, there is caused a phenomenon that a measured value varies even when a patch image having the same toner adhesion amount is measured, resulting in a problem that the detecting precision is lowered on the high density section side.

Taking the aforesaid problem into consideration, an object of the invention is to conduct precisely correction control for image forming conditions.

### SUMMARY OF THE INVENTION

(1) To achieve the abovementioned object, an image forming apparatus reflecting one aspect of the present invention includes therein an image carrier, an exposure section that gives exposure to the image carrier for forming a latent image, a developing section that develops the latent image with toner, a density sensor that is equipped with a light emitting section and a light receiving section to measure patch images which are formed on a surface of the image carrier for density detection and a controller that forms patch images having respectively plural density types in which image forming conditions are different respectively and conducts correction control for image forming conditions based on measured values by the aforesaid density sensor for the patch images, and in which, the aforesaid controller causes irradiation light amount “a” (also referred to as the first irradiation light amount) in the case of measuring patch images whose ratio covered by toner of the aforesaid image carrier measured by the aforesaid light emitting section is the prescribed value or more to be different from irradiation light amount “e” (also referred to as the second irradiation light amount) in the case of measuring patch images whose ratio covered by toner of the aforesaid image carrier measured by the aforesaid light emitting section is less than the prescribed value.

(2) In the image forming apparatus in the aforesaid (1), it is preferable that the aforesaid controller forms patch images in which the ratio covered by toner is made to be different by changing an exposure area ratio by the exposure section.

(3) In the image forming apparatus in the aforesaid (2), it is preferable that the patch images in which the aforesaid ratio covered by toner is the prescribed value or more are solid images and patch images in which the aforesaid ratio covered by toner is less than the prescribed value are images in intermediate density.

(4) In the image forming apparatus described in either one of the aforesaid (1), (2) and (3), it is preferable that the aforesaid irradiation light amount “a” is a prescribed established value, and the aforesaid irradiation light amount “e” is an irradiation light amount that is adjusted so that the measured value obtained after measuring a surface of the image carrier under the condition of forming no patch images may be prescribed value “d” (also referred to as a first prescribed voltage value).

(5) In the image forming apparatus described in the aforesaid (4), it is preferable that, a measured value obtained by measuring a surface of the image carrier under the condition of forming no patch images is made to be measured value “b” (also referred to as a second prescribed voltage value) when the image carrier is replaced, the aforesaid irradiation light amount “a” is an irradiation light amount that is adjusted so that a measured value obtained after measuring a surface of the replaced image carrier under the condition of forming no patch images may be the measured value “b”.

(6) In the image forming apparatus described in either one of the aforesaid (1)-(5), it is preferable that the aforesaid controller controls a ratio of a moving speed of the image carrier to a moving speed of a developer carrier of the aforesaid developing section based on the measured value of patch images whose ratio of area covered by toner for the image carrier is the prescribed value or more, and controls an exposure amount of the aforesaid exposure section based on the measured value of patch images whose ratio of area covered by toner for the image carrier is less than the prescribed value.

### BRIEF DESCRIPTION OF THE DRAWINGS

FIG. 1 is a sectional structure diagram showing an image forming section of an image forming apparatus relating to the present embodiment.

Each of FIGS. 2A-2B is a pattern diagram for illustrating a density sensor.

FIG. 3 is a control block diagram of an image forming apparatus relating to the present embodiment.

FIG. 4 is a control flow diagram in correction control that is practiced by an image forming apparatus.

FIG. 5 is a graph showing corresponding relationship between a toner adhesion amount and a density sensor output voltage.

FIG. 6 is a graph showing corresponding relationship between a toner adhesion amount and a density sensor output voltage.

Each of FIGS. 7A-7B is a diagram for illustrating a control flow relating to calibration of density sensor.

### DETAILED DESCRIPTION OF THE PREFERRED EMBODIMENT

The invention will be explained as follows, based on the embodiment of the invention, to which, however, the invention is not limited.

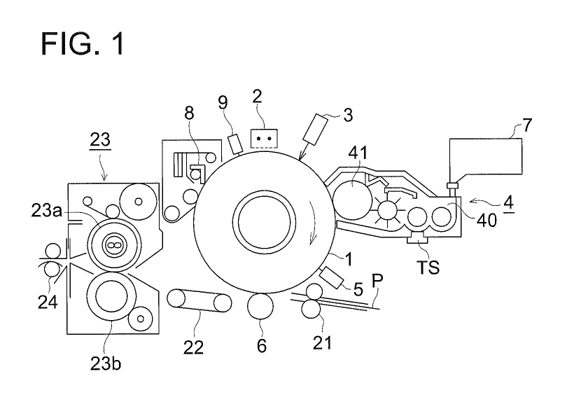

FIG. 1 is a sectional structure diagram showing an image forming section of an image forming apparatus relating to the present embodiment Photoreceptor 1 is made of a drum whose diameter is 80 mm. The photoreceptor 1 is one wherein those in which phthalocyanine pigments are dispersed in polycarbonate are coated on a surface of a grounded cylindrical base body made of aluminum as an organic semiconductor layer charged negatively to form a layer thickness of a photoreceptor layer including a charge transport layer totaling in terms of a thickness to be 30 μm, and the photoreceptor 1 is driven to rotate clockwise at a circumferential speed of 500 mm per second (Vp) in FIG. 1. Incidentally, in the embodiment for FIG. 1 or the like, an explanation will be given with an example of a photoreceptor in a form of a drum, as an image carrier that carries a toner image. However, another example for the image carrier may also be a belt-shaped photoreceptor or an intermediate photoreceptor. Meanwhile, in the present embodiment, with respect to a substratum of photoreceptor 1 (which is also called an aluminum elementary tube), its degrees of accuracy (smoothness of the surface and circularity) are secured by cutting processing, but there is sometimes an occasion where an influence of cutting processing causes degrees of reflection for individual photoreceptor 1 to differ greatly from others. Its scattering of degrees of reflection is more dominant than aged deterioration caused by use of the photoreceptor 1.

Charging electrode 2 conducts charging processing uniformly for the circumference of rotating photoreceptor 1 by using a charging device of a scorotron mode so that the circumference may become uniform in terms of a prescribed polarity and voltage. The charging electrode 2 has a charging electrode structure wherein a distance between a wire and grid is 7.5 mm, a distance between a grid and a photoreceptor is 1 mm and a distance between a wire and a back plate is 12 mm, and the charging electrode 2 makes surface voltage of the photoreceptor 1 to be −750 V by making grid impression voltage to be −730 V and by charging with charging current value from −800 μA to −1800 μA.

Exposure section 3 is equipped with a plurality of light emitting diodes (LED; Light Emitting Diode) arranged in the main scanning direction (rotational axis direction of photoreceptor 1) as an exposure light source, and is equipped with optical member in which plural GRIN (Graded-Index) lenses are arranged in the main scanning direction, and the LED is driven selectively based on image data, and light irradiated from the driven LED converges on photoreceptor 1 to form an image. A surface of the photoreceptor 1 charged evenly by charging electrode 2 is given scanning exposure by the exposure section 3, and an electrostatic latent image is formed. With respect to respective LED elements in the exposure section 3, driving current or light emitting time for them is corrected in advance so that a light amount for each LED element may become identical to others.

Developing section 4 develops the electrostatic latent image existing on photoreceptor 1 to be a toner image with developing roller 41 that rotates while facing the photoreceptor 1. Contact developing or noncontact developing is carried out, as developing by using two-component developer in a combination of image exposure and reversal development. The developing roller 41 serving as a developer carrier is of the structure wherein the circumference of a magnetic roll is covered by a sleeve made of aluminum that is processed by surface treatment of stainless steel thermal spraying, and a roller diameter of the developing roller 41 is 40 mm. The inner magnetic roll is fixed, and the outer sleeve rotates, and its speed of rotation (movement speed) can be changed and controlled within a range of linear speed (Vs) of 500-1000 mm/s. For the developing roller 41, developing is carried out by developing bias of direct current component, and as a direct current component, developing bias of −600 V is impressed and reversal development is carried out.

In developer storage section 40, there are stored two-component developers containing nonmagnetic toner and magnetic carrier. Toner concentration of developers stored in the developer storage section 40 is detected by toner concentration sensor TS that is provided on the developer storage section 40. The toner concentration sensor TS detects magnetic permeability of the developer in the vicinity of a detection surface, and detects toner concentration in the developer based on the results of the aforesaid detection. Then, when the toner concentration is declined to be lower than its threshold value, there is conducted control so that fresh toner may be supplied from toner supply section 7, whereby, prescribed toner concentration is maintained for developers in the developer storage section 40. Incidentally, the toner concentration mentioned here is a mass ratio of toner mass (Wt) in developers to carrier mass (Wc), and it is expressed as follows.

Toner concentration=(Wt/(Wt+Wc))×100(%)

As nonmagnetic toner, polymerized toner whose volume average grain size is 3-9 μm is preferable. By using polymerized toner, it is possible to realize an image forming apparatus wherein resolving power is high, density is stable and an amount of occurrence of fogs is extremely small.

As a carrier, a ferrite-core carrier composed of magnetic grains whose volume average grain size is 30-65 μm and magnetized amount is 20-70 emu/g is preferable. In the case of a carrier whose grain size is smaller than 30 μm, carrier adhesion tends to be caused. Further, in the case of a carrier whose grain size is greater than 65 μm, there is sometimes an occasion where an image with uniform density is not formed.

In the density sensor 5, density of patch images for detecting the developability is measured. Details will be described later.

A toner image on photoreceptor 1 is transferred onto a sheet by transfer roller 6, through control of constant current of transfer current 40-80 μA.

Sheet P supplied from a sheet supply section is further supplied by registration rollers 21 to be synchronized with a toner image formed on photoreceptor 1, and it receives transferring of the toner image conducted by transfer roller 6 in transfer nipping section. Sheet P that has passed through the transfer nipping section is separated by a curvature from the surface of photoreceptor 1, to be conveyed to fixing unit 23 by conveyance belt 22.

The fixing unit 23 is composed of heating roller 23a having therein an arranged heater and of pressurizing roller 23b, and sheet P holding thereon a toner image is heated and pressurized between the heating roller 23a and the pressurizing roller 23b, to be fixed, and is ejected out by sheet ejection roller 24 to an unillustrated sheet ejection tray that is located to be outside the apparatus.

On the other hand, a surface of photoreceptor 1 from which the toner image has been transferred onto sheet P is cleaned by cleaning section 8 so that residual toner may be eliminated. In the present example, a blade made of urethane rubber is used as a cleaning blade which rubs a circumferential surface of photoreceptor 1 for cleaning. The circumferential surface of photoreceptor 1 that has passed through the cleaning section 8 so that a surface of the circumferential surface may be cleaned is irradiated by pre-charging exposure section 9 (PCL) employing a light source having a light wavelength of 700 nm and a 10-lux output of light and the circumferential surface proceeds to the next image forming cycle under the condition that residual electric potential is lowered.

### [Density Sensor 5]

Each of FIGS. 2A-2B is a pattern diagram for illustrating a density sensor. FIG. 2A is a side view of density sensor 5, and FIG. 2B shows a detection area of the density sensor 5. The density sensor 5 is a reflection type density sensor that has therein LED that irradiates photoreceptor 1 representing an image carrier with light (hereinafter, referred to as light emitting section 5A) and a photodiode that receives reflected light coming from photoreceptor 1 (hereinafter, referred to as light receiving section 5B). Further, a patch image is formed to be greater than detection area E sufficiently.

Density D of toner image T on photoreceptor 1 is in relationship shown by expression (1), for reflectance R of detection area E detected by density sensor 5.

D=−log 10R (1)

As is shown in FIG. 2B, there is sometimes an occasion where a plurality of images T exist in detection area E of density sensor 5, and the reflectance R is expressed by the following expression (2) and it is an average reflectance of the detection area E.

R=A×DR+(1−A)×WR (2)

In the expression (2) above, A represents a toner covering rate, namely, it is a rate of an area occupied by image T to an area of detection area E, DR represents a reflectance of toner constituting toner image T, and WR represents a reflectance of a background of photoreceptor 1. As is apparent from the expression (2), the higher a toner covering rate is, the less an influence of reflectance of a background of photo photoreceptor 1 becomes, and the reflectance of toner becomes to be dominant.

Incidentally, in the present embodiment, image data to be used for forming a patch image are those wherein an exposure area rate in a patch image having maximum density is 100% (solid image), and are those of a longitudinal line extending in the sub-scanning direction wherein an exposure area rate in a patch image having intermediate density is from 20% to 80%. For example, in the case of the exposure area rate 50%, there are used longitudinal line image data wherein 40 lines-on and 40 lines-off continue as a unit of 8-lines (1200 dpi), while, in the case of the exposure area rate 62.5%, there are used longitudinal line image data wherein 3 lines-off and 5 lines-on continue.

### [Control Block]

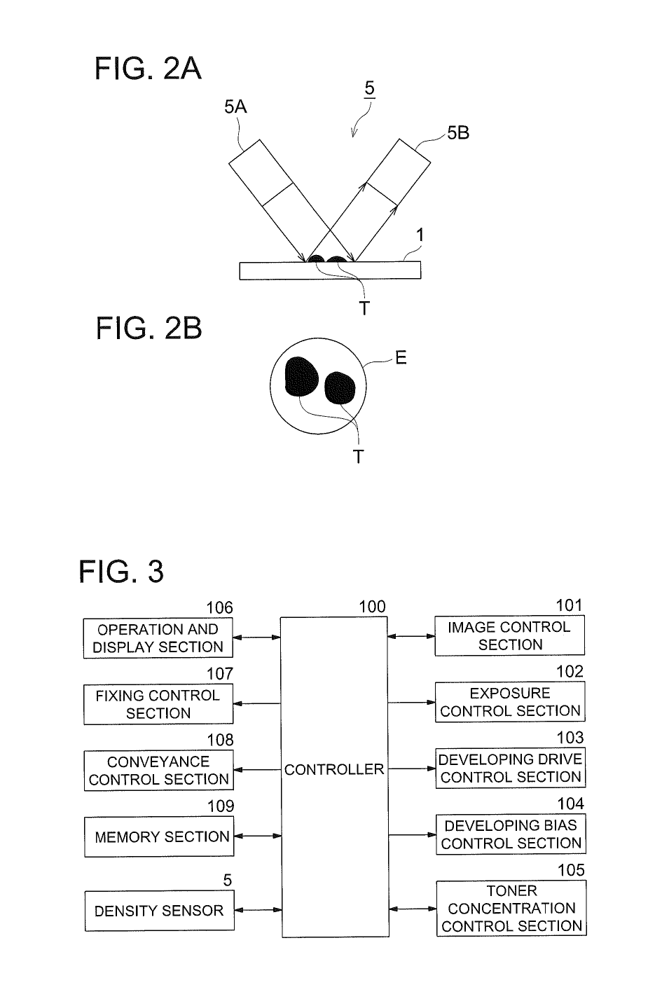

FIG. 3 is a control block diagram of an image forming apparatus relating to the present embodiment. As is shown in FIG. 3, an image forming apparatus is composed of controller 100, image control section 101, exposure control section 102, developing drive control section 103, developing bias control section 104, toner concentration control section 105, operation and display section 106, fixing control section 107, conveyance control section 108, memory section 109 and of density sensor 5.

The controller 100 is composed of CPU (Central Processing Unit) and others and it reads out system programs stored in memory section 109 and programs designated from various types of application programs to develop them to the work area in the memory section 109, and the controller 100 carries out various types of processing and controls respective sections of the image forming apparatus intensively, in cooperation with developed programs.

The controller 100 forms plural patch images whose density is made to be different from others by controlling respective portions, and carries out correction control for image forming conditions, based on measured values coming from the density sensor 5. The correction control is processing to maintain stability of image quality of images formed on sheets in an image forming apparatus. Image forming conditions include surface potential of photoreceptor 1, developing bias voltage on developing roller 41, an amount of exposure in exposure section 3, a number of revolutions of developing roller 41 by developing drive control section 103 and toner concentration of developer in developer storage section 40 controlled by toner concentration control section 105 or tone correction that corrects a tone curve of concentration.

Meanwhile, in the present embodiment, effective tinting for the correction control includes (1) a moment when the number of ejected sheets has arrived at the prescribed number of sheets (for example, 1000 sheets), (2) a moment to start succeeding operations after a downtime (an idling time and a power-off time) has elapsed a prescribed time (for example, 360 minutes) and (3) an occasion when practice of correction actions is instructed by a user through operation and display section 106.

The operation and display section 106 is composed of a display section and an operation section. Namely, the operation and display section 106 is composed of LCD (Liquid Crystal Display) serving as a display section and of a touch panel provided to cover the LCD or of an operation section such as an unillustrated operation keys. In the operation and display section 106, an input of a user is received, and its input information is outputted to controller 100, and various types of setting screens and various type of processing results for inputting various types of setting conditions are displayed depending on display signals inputted from the controller 100. When replacement items such as photoreceptor 1 and developers in developing section 4 are replaced by a service staff, information for that effect is inputted in the operation and display section 106. Further, in that case, it is possible to input an indication to conduct various types of initial operations or initial adjustment.

The image control section 101 generates print data by conducting various processes for image data which are read by an unillustrated scanner or for image data transmitted from an external terminal such as a personal computer, following instructions from the controller 100. Further, drive controls for respective portions of the image forming apparatus are conducted, following instructions from controller 100.

The memory section 109 forms a work area that stores correction control program relating to the present embodiment, image data wherein various types of exposure area rates for forming test patterns are made to be different, and data processed by various types of programs, in addition to various types of programs relating to image forming and various types of data, and stores temporarily various types of programs carried out by controller 100, data related to these programs and job data.

Following the instructions from controller 100, fixing control section 107 controls a temperature of fixing unit 23, or controls a motor and others which drive heating roller 23a and pressurizing roller 23b.

Following instructions from the controller 100, conveyance control section 108 controls a motor and others that drive a plurality of conveyance rollers, registration rollers 21 and transfer roller 6 which are provided on an unillustrated sheet supply section.

### [Control Flow]

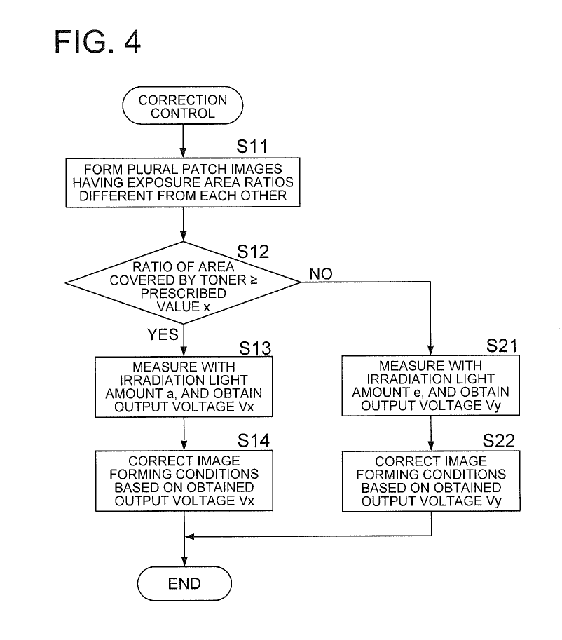

FIG. 4 is a control flow diagram in correction control that is practiced by an image forming apparatus. Meanwhile, an effective timing for the control flow in FIG. 4 is an occasion when the number of ejected sheets arrives at the prescribed number of sheets as stated earlier.

In step S11, controller 100 forms a plurality of patch images each being different from others in terms of an exposure area rate. The exposure area rates are, for example, 100% and 50%. In the present embodiment, there is formed a patch image on which a toner covering rate on a surface of photoreceptor 1 is made to be different by changing an exposure area rate with exposure control section 102. Incidentally, in the present embodiment, an exposure area rate and a toner covering rate nearly agree with each other in terms of a value, because developing conditions for toner are adjusted so that the exposure area rate and the toner covering rate may agree with each other (by the correction control mentioned earlier or by the initial adjustment. Meanwhile, details of irradiation light amount “a” (also referred to as a first irradiation light amount) and of irradiation light amount “e” (also referred to as a second irradiation light amount) used in the control flow will be explained later.

When the toner covering rate of a patch image is not less than prescribed value x (step S12: Yes), density sensor 5 measures under the condition that the irradiation setting of light emitting section 5A is irradiation light amount “a” (step S13). An output voltage at light receiving section 5B acquired in this measurement is made to be Vx. Incidentally, as prescribed value “x”, for example, toner covering rate is made to be 80%, because a reflection from toner is dominant when toner covering rate is 80% or more. When the prescribed value is “x” or more, photoreceptor 1 is covered by a toner of patch image in the case of measurement, and a bare surface (background) of photoreceptor 1 is hardly exposed. In this case, an influence of a reflection of photoreceptor 1 is small in the measurement by the density sensor 5, as explained in the aforesaid expression (2). On the other hand, when the prescribed value is less than “x”, the bare surface of photoreceptor 1 is exposed, and an influence of a reflection of photoreceptor 1 is not small.

In step S14, correction control for image forming conditions is conducted based on output voltage Vx obtained in step S13. The output voltage Vx is a measured value of a patch image having high toner covering rate such as a solid image, and correction control for the highest density is carried out based on that measured value. Image forming conditions to be fed back includes (1) surface potential on photoreceptor 1 having an influence on the highest density, (2) developing bias voltage for developing roller 41, (3) a number of revolutions of developing roller 41 by developing drive control section 103 and (4) toner concentration of developer in developer storage section 40 by toner concentration control section 104. In the present embodiment, peripheral speed ratio Vs/Vp between photoreceptor 1 and developing roller 41 is changed by changing a number of revolutions of the developing roller 41 by comparing output voltage Vx with target voltage VxO.

On the other hand, when the toner covering rate is less than the prescribed value “x” (step S12: No), density sensor 5 conducts measurement under the condition that the irradiation setting of light emitting section 5A is irradiation light amount “e” (step S21). An output voltage at light receiving section 5B acquired in this measurement is made to be Vy.

In step S22, correction control for image forming conditions is conducted based on output voltage Vy acquired in step S21. The output voltage Vy is a measured value of a patch image having toner covering rate that is not high such as an image with intermediate density. Based on this measured value, correction control for intermediate density or for a tone curve is conducted based on this measured value. An image forming condition for those to be fed back includes an exposure amount of exposure section 3 that has influence on intermediate density. In the present embodiment, an exposure amount of exposure section 3 is changed by comparing output voltage Vy with target voltage VyO.

### [Irradiation Light Amount]

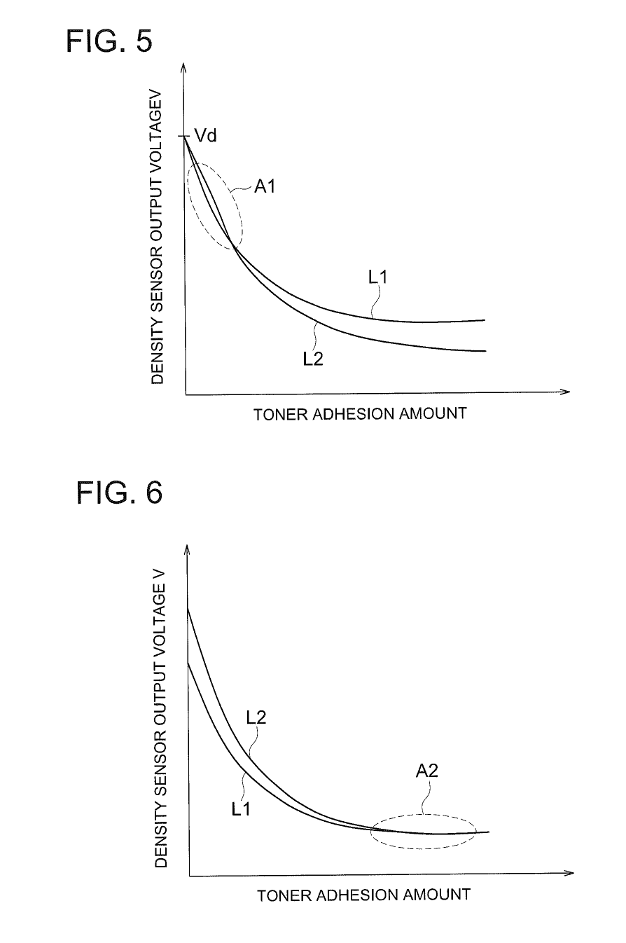

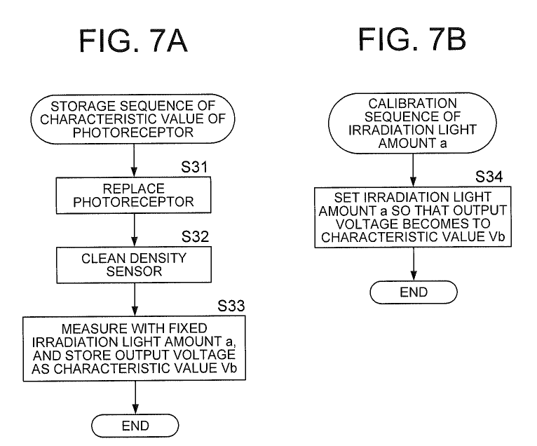

Each of FIGS. 5 and 6 is a graph showing corresponding relationship between a toner adhesion amount and density sensor output voltage. The horizontal axis represents a toner adhesion amount and the vertical axis represents output voltage of density sensor. A change of a toner adhesion amount is made by changing an exposure area rate of a patch image. Each of L1 and L2 shows a characteristic curve in the case of using two photoreceptors which are different each other in terms of reflectance, and the reflectance on a surface is in the relation of photoreceptor L1<photoreceptor L2.

First, “irradiation light amount e” will be explained based on FIG. 5. The irradiation light amount “e” is a light amount of light emitting section 5A in the case of measuring patch images wherein toner covering rate of photoreceptor 1 is less than a prescribed value. In the case of measuring, there is a reflection from photoreceptor 1, and its influence cannot be ignored. The irradiation light amount “e” is one wherein adjustment is made so that a measured value in the case of measuring photoreceptor 1 under the condition of forming no patch image may become prescribed output voltage Vd (measured value “d”, and also referred to as a first prescribed voltage value). In this case, irradiation light amount “e” adjusted with photoreceptor L1 having low reflectance has become greater when it is compared with one for photoreceptor L2.

A graph in FIG. 5 shows corresponding relationship between a toner adhesion amount and a density sensor output for two types of photoreceptors with adjusted irradiation light amount (“e”), under the condition that irradiation light amount is adjusted so that it may become a prescribed output voltage Vd under the state (surface measurement) of forming no patch image. As is shown in FIG. 5, it is understood that photoreceptors L1 and L2 which are different from each other in terms of the reflectance are showing similar output voltage, in patch images covering from low density area A1 (in other words, toner covering rate is low) where toner adhesion amount is less up to an area of intermediate density. On the other hand, in patch images with high density where toner adhesion amount is large (in other words, toner covering rate is high), an output voltage for photoreceptor L1 is extremely different from that for photoreceptor L2. The reason for this is that the adjusted irradiation light amount “e” for photoreceptor L1 is different from that for photoreceptor L2 because toner reflection is dominant in the area where toner covering rate is high. On the photoreceptor L1 wherein irradiation light amount “e” is adjusted to be a little larger, output voltage shows a value that is a little higher in the area where toner covering rate is high (toner adhesion amount is large).

The problems mentioned above can be solved by making an irradiation light amount to be fixed irradiation light amount “a” so that the reflectance of the photoreceptor may not affect. “Irradiation light amount a” will be explained based on FIG. 6.

A graph in FIG. 6 shows corresponding relationship between a toner adhesion amount and a density sensor output with a fixed irradiation light amount “a” for two types of photoreceptors which are the same as those in FIG. 5. When measuring two types of photoreceptors L1 and L2 with common irradiation light amount “a” as is shown in FIG. 6, the same output voltage is shown for photoreceptor L1 and photoreceptor L2 in high density patch images in area A2 having large amount of toner adhesion amount (in other words, high toner covering rate). The reason for this is that even when the reflectance of the photoreceptor is different, the difference does not affect. On the other hand, output voltage for the patch images having low density with less toner adhesion amount is extremely different from that for the patch images having intermediate density.

Based on these characteristics, fixed irradiation light amount “a” is used for measurement for the area having a high toner covering rate (FIG. 6), and adjusted irradiation light amount “e” is used for measurement for the area having a low toner covering rate so that prescribed output voltage Vd may be acquired, in the present embodiment. By doing this, it is possible to measure density accurately for a broad range covering from low density to high density without depending on reflectance of a photoreceptor, resulting in possibility of accurate correction of image forming conditions.

### [Calibration of Irradiation Light Amount]

FIGS. 7A-7B are diagrams for illustrating control flows relating to calibration of density sensor. A service staff carries out replacement of photoreceptor 1 as an image carrier at a prescribed cycle such as, for example, 100K-1000K prints.

FIG. 7A is a control flow for the calibration of a density sensor that is conducted when photoreceptor 1 is replaced, and by this control, a peculiar value of photoreceptor 1 is stored. Replacement of photoreceptor 1 by a service staff and inputting of history updating information and an instruction for starting initial adjustment following the replacement cause controller 100 to recognize the replacement of the photoreceptor 1 (step S31). Further, following the replacement, the service staff cleans the density sensor in case of need (step S32).

In step S33, a rough surface of photoreceptor 1 on which a patch image is not formed with fixed irradiation light amount “a” is measured, and output voltage in this case is stored in memory section 109 as peculiar value Vb (peculiar value “b”, and also referred to as a second prescribed voltage value).

FIG. 7B is a diagram of a control flow relating to calibration carried out on an irregular base when a service staff inputs into operation and display section 106. The FIG. 7B is one to calibrate changes in sensitivity caused by toner contamination on a surface of the density sensor after it is used.

In step S34 of FIG. 7B, an irradiation light amount is adjusted so that output voltage of density sensor 5 may become peculiar value Vb stored in step S31, and its adjusted irradiation light amount is established as a new irradiation light amount “a”. The established irradiation light amount “a” is stored in the memory section 109, and correction control for image forming conditions thereafter are carried out by using the irradiation light amount “a” established in step S34.

By doing this, it is possible to conduct correction control accurately for image forming conditions, because it is possible to conduct calibration even when density sensor 5 is contaminated.

In the present embodiment, it becomes possible to conduct correction control for image forming conditions accurately not only for low density and intermediate density but also for high density, by conducting density measurement under the settings in which irradiation light amount “a” in the case of measuring a patch image whose toner covering rate is a prescribed value or more is different from irradiation light amount “e” in the case of measuring a patch image whose toner covering rate is less than a prescribed value.

What is claimed is:

1. An image forming apparatus comprising:
(a) an image carrier;
(b) an exposure section that exposes the image carrier to form a latent image;
(c) a developing section that develops the latent image with toner;
(d) a density sensor for a density detection provided with a light emitting section and a light receiving section, that measures density of patch images formed on a surface of the image carrier, and
(e) a controller that forms patch images having respectively plural density types in which image forming conditions are different respectively and corrects the image forming conditions based on measured density values of the patch images by the density sensor,
wherein the controller causes a first irradiation light amount by the light emitting section when measuring patch images whose ratio covered by toner of the image carrier is a prescribed value or more to be set different from a second irradiation light amount by the light emitting section when measuring patch images whose ratio covered by toner of the image carrier is less than the prescribed value, and
wherein the first irradiation light amount represents a prescribed set value, and the second irradiation light amount represents an irradiation light amount which is adjusted so that a measured value of the surface of the image carrier without forming patch image thereon becomes a first prescribed voltage value.

2. The image forming apparatus of claim 1, wherein the controller forms patch images in which the ratio covered by toner is made to be different by changing an exposure area ratio by the exposure section.

3. The image forming apparatus of claim 2, wherein the patch images in which the ratio covered by toner is the prescribed value or more are solid images and the patch images in which the ratio covered by toner is less than the prescribed value are images having intermediate density.

4. The image forming apparatus of claim 1, wherein when the image carrier is replaced with a newly provided image carrier and a measured value obtained by measuring a surface of the replaced image carrier without forming patch images represents a second prescribed voltage value, the first irradiation light amount is an irradiation light amount that is adjusted so that the measured value obtained after measuring the surface of the replaced image carrier without forming patch images becomes the second prescribed value.

5. The image forming apparatus of claim 1, wherein the controller controls a ratio of a moving speed of the image carrier to a moving speed of a developer carrier of the developing section based on the measured density value of patch images whose ratio of area covered by toner for the image carrier is the prescribed value or more, and controls an exposure amount of the exposure section based on the measured density value of patch images whose ratio of area covered by toner for the image carrier is less than the prescribed value.

6. An image forming method comprising the steps of
(a) forming a latent image by exposing an image carrier with an exposure section;
(b) developing the latent image with toner;
(c) measuring density of patch images formed on a surface of the image carrier by a density sensor provided with a light emitting section and a light receiving section;
(d) forming patch images having respectively plural density types in which image forming conditions are different respectively;
(e) correcting the image forming conditions based on measured density values of the patch images by the density sensor; and
(f) setting a first irradiation light amount by the light emitting section when measuring patch images whose ratio covered by toner of the image carrier is a prescribed value or more, to be different from a second irradiation light amount when measuring patch images whose ratio covered by toner of the image carrier is less than the prescribed value,
wherein the first irradiation light amount represents a prescribed set value, and the second irradiation light amount represents an irradiation light amount which is adjusted so that a measured value of the surface of the image carrier without forming patch image thereon becomes a first prescribed voltage value.

7. The image forming method of claim 6, wherein the step of forming patch images includes forming patch images in which the ratio covered by toner is made to be different by changing an exposure area ratio by the exposure section.

8. The image forming method of claim 7, wherein the step of forming patch images includes forming the patch images in which the ratio covered by toner is the prescribed value or more are solid images and the patch images in which the ratio covered by toner is less than the prescribed value are images having intermediate density.

9. The image forming method of claim 6, wherein when the image carrier is replaced with a newly provided image carrier and a measured value obtained by measuring a surface of the replaced image carrier without forming patch images represents a second prescribed voltage value, the first irradiation light amount is an irradiation light amount that is adjusted so that the measured value obtained after measuring the surface of the replaced image carrier without forming patch images becomes the second prescribed value.

10. The image forming method of claim 6, further comprising the step of:
controlling a ratio of a moving speed of the image carrier to a moving speed of a developer carrier of the developing section based on the measured density value of patch images whose ratio of area covered by toner for the image carrier is the prescribed value or more; and
controlling an exposure amount of the exposure section based on the measured density value of patch images whose ratio of area covered by toner for the image carrier is less than the prescribed value.
